(19) United States
(12) Patent Application Publication
(10) Pub. No.: US 2011/0252933 A1
(43) Pub. Date: Oct. 20, 2011

(54) BURST CUTTING DIE PLATES, SYSTEM, AND METHOD

(75) Inventor: Sean TALKINGTON, South Bend, IN (US)

(73) Assignee: ATLAS DIE, LLC, Elkhart, IN (US)

(21) Appl. No.: 12/759,798

(22) Filed: Apr. 14, 2010

(51) Int. Cl. B26F 1/44; B26F 1/40

(52) U.S. Cl. 83/13; 83/679; 83/613

(57) ABSTRACT

A set of burst cutting dies is provided and includes an upper die plate and a lower die plate. The set of burst cutting dies can be mounted within a flat die press to form a burst cutting die press. The upper die plate can have a working surface having a substantially uniform minimum thickness defining a recessed surface across a majority of the area of the working surface. A plurality of workpiece manipulating features can extend from the recessed surface to defile areas of the working surface having thicknesses that are greater than the uniform minimum thickness. The lower die plate can have a working surface having a substantially uniform maximum thickness defining a contact surface across a majority of the area of the working surface. A plurality of workpiece manipulating features can be recessed from the contact surface to define areas of the working surface having thicknesses that are less than the maximum thickness. A method of burst cutting using the burst cutting die press is also provided.

### FIELD

The present teachings relate to die plates for cutting, creasing, and/or scoring sheet material such as paperboard or corrugated paperboard.

### BACKGROUND

Various consumer products are marketed in paper boxes, such as paperboard or corrugated paperboard boxes, which require assembly prior to use. Sheet material formed from paper products, such as paperboard or corrugated paperboard, are cut into a desired shape and scored to form fold lines, in order to facilitate subsequent assembly of the boxes. In the past, burst cutting die plates used to form such boxes have been flexible so that the die plates could be an integral part of, or mounted upon, high speed cylinders for high speed production. In such production methods, sheet material is cut along predetermined cutting lines by rotary pressure cutting which requires curved surfaces and causes dimensional intolerances. It would be desirable to provide flat burst cutting die plates that facilitate a flat cutting process, rather than a rotary cutting process.

### SUMMARY

Features and advantages of the present teachings will become apparent from the following description. This description, which includes drawings and examples of specific embodiments, provides a broad representation of the present teachings. Various changes and modifications to the teachings will become apparent to those skilled in the art from this description and by practice of the teachings.

The present teachings relate to a set of burst cutting dies, a burst cutting die press, and a method of burst cutting. The set of burst cutting dies can have an upper die plate and a lower die plate. The upper die plate and the lower die plate can be mounted within a die cutting press for cutting a workpiece such as a paperboard blank. The upper die plate and the lower die plate can remain flat during the cutting process. Because the upper die plate and lower die plate are not required to bend during the cutting process, there is less likelihood of misalignment of the die cutting plates and their cutting features. Consequently, the potential for snagging of diecut parts or pieces of waste in one or more cavities of a die cutting plate are also minimized.

In some embodiments, the set of burst cutting dies comprise an upper die plate and a lower die plate that can comprise iron, steel, stainless steel, aluminum, titanium, alloys thereof, and the like. The upper die plate and the lower die plate can exhibit a Rockwell hardness of at least 40 on the C scale, for example, at least 45, at least 50, or at least 55. The upper die plate can have a mounting surface for mounting against a press and a working surface opposite the mounting surface. The upper die plate and the lower die plate can each comprise a respective substantially flat or completely flat mounting surface. The working surface can comprise an area, and a substantially uniform minimum thickness defining a recessed surface across a majority of the area of the working surface. The working surface can comprise a plurality of workpiece manipulating features extending from the recessed surface to define areas of the working surface having thicknesses that are greater than the minimum thickness, for example, 50% or greater, 75% or greater, or 100% or greater. The areas of the working surface having thicknesses that are greater than the minimum thickness can together comprise an area that is less than 50% of the total area of the working surface, for example, less than 20%, less than 10%, less than 5%, less than 4%, less than 3%, or less than 2% of the entire area of the working surface.

The lower die plate can have a mounting surface for mounting against a press and a working surface opposite the mounting surface. The working surface can have an area, and a substantially uniform maximum thickness defining a contact surface across a majority of the area of the working surface. The working surface can have a plurality of workpiece manipulating features recessed from the contact surface to define areas of the working surface having thicknesses that are less than the maximum thickness, for example, 75% as thick, 60% as thick, or 50% as thick as the uniform maximum thickness. The areas of the working surface having thicknesses that are less than the uniform maximum thickness can together comprise less than 50% of the total area of the working surface, for example, less than 20%, less than 10%, less than 5%, less than 4%, less than 3%, or less than 2% of the entire area of the working surface.

In operation, the workpiece manipulating features of the upper die plate can be aligned with the workpiece manipulating features of the lower die plate.

In some embodiments, the present teachings provide a die cutting press comprising an upper burst cutting die mounted to an upper platen of the die cutting press, and a lower burst cutting die mounted to a lower platen of the die cutting press. The upper die plate and the lower die plate can comprise die plates as described herein.

In some embodiments, the present teachings provide a method of burst cutting a workpiece. The method of burst cutting a workpiece can comprise positioning a workpiece between an upper burst cutting die mounted to an upper platen of a burst cutting die press, and a lower burst cutting die mounted to a lower platen of the die cutting press, according to the present teachings. The upper burst cutting plate and the lower burst cutting plate can be brought together with the workpiece positioned there between, to manipulate the workpiece. The upper die plate can comprise a burst cutting die plate as described herein. The lower die plate can comprise a burst cutting die plate as described herein. The upper and lower die plates can be mounted such that the workpiece manipulating features of the upper die plate are aligned with the workpiece manipulating features of the lower die plate. Alignment features can be provided to facilitate alignment of the upper and lower plates.

While the two opposing die plates are herein referred to generally as upper and lower die plates, it is to be understood that they can be reversed, arranged side by side, or arranged at an angle, and still be within the scope of the present teachings.

### BRIEF DESCRIPTION OF THE DRAWINGS

The accompanying drawings, which are incorporated into and constitute a part of the specification, illustrate specific embodiments of the invention, and taken in conjunction with the detailed description of the specific embodiments, serve to explain the principles of the invention.

FIG. 1 is a fragmented cross-sectional view of a set of burst cutting dies, according to various embodiments of the present teachings.

FIG. 2 is a top plan view of the working surface of an upper die plate, according to various embodiments of the present teachings.

FIG. 3 is a top plan view of the working surface of a lower die plate, according to various embodiments of the present teachings, and useful in open flow and closed loop systems.

FIG. 4 is a side view of a burst cutting die press showing an upper die plate and a lower die plate mounted therein, according to various embodiments of the present teachings.

FIG. 5 is a perspective view of the burst cutting die press shown in FIG. 4, wherein the upper die plate has been removed and showing a paperboard product and skeleton resulting from a burst cutting operation, according to various embodiments of the present teachings.

### DETAILED DESCRIPTION

The following detailed description serves to explain the principles of the present teachings. The present teachings are susceptible to modifications and alternative forms and are not limited to the particular forms disclosed herein. The present teachings cover modifications, equivalents, and alternatives.

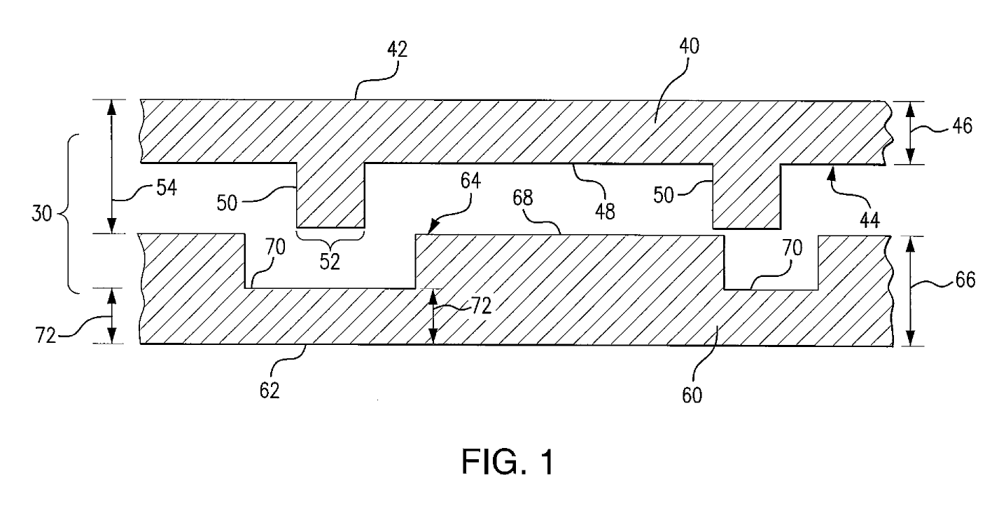

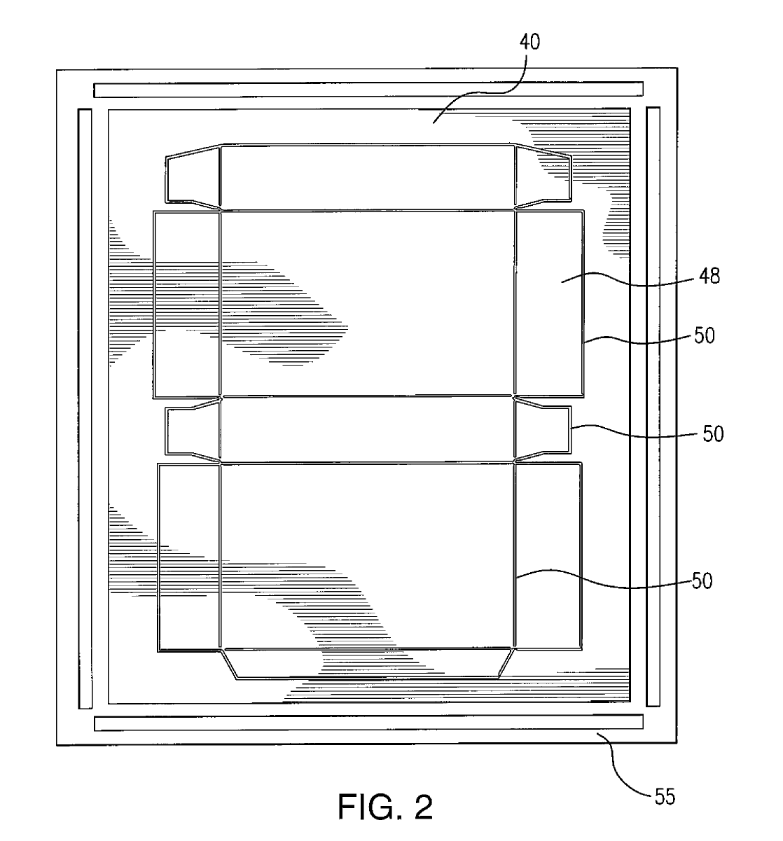

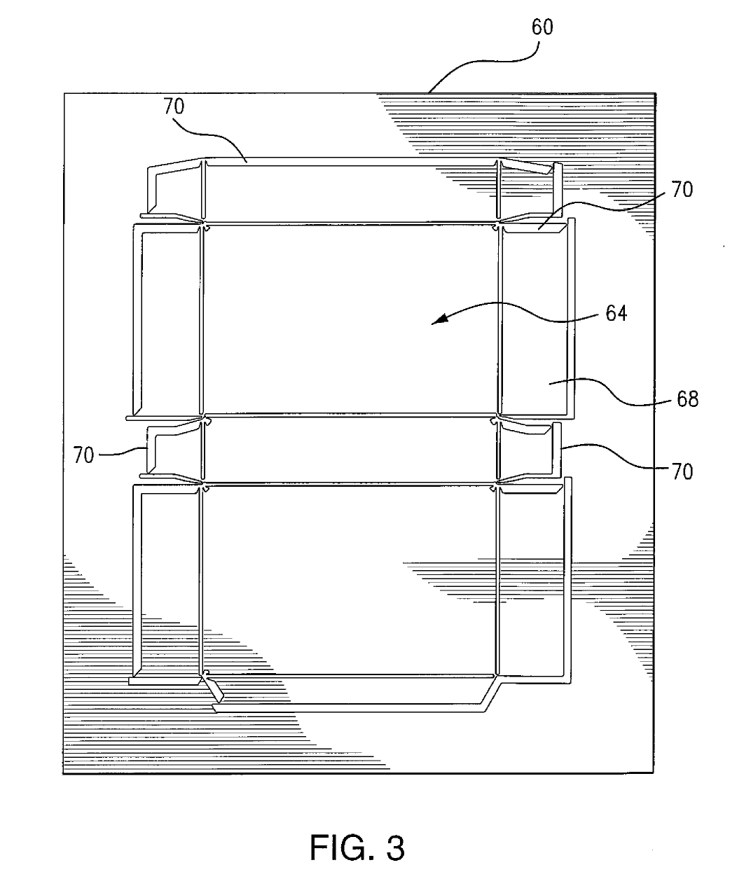

According to various embodiments of the present teachings, a set 30 of burst cutting dies is shown in FIG. 1. Set 30 can be useful for cutting, shaping, scoring, and/or creasing a workpiece, for example, to manipulate a paperboard blank or stock sheet. The workpiece can be any sheet material formed from paper or paper products, for example, products suitable for forming paper boxes. The workpiece can comprise, for example, paperboard or corrugated paperboard. Set 30 of burst cutting dies can comprise an upper die plate 40 and a lower die plate 60. FIG. 2 is a top plan view of a working surface of an exemplary upper die plate 40. Upper die plate 40 is also referred to herein as a cutting plate, a male burst cutting die plate, or an upper burst cutting die plate. FIG. 3 is a top plan view of the working surface of an exemplary lower die plate 60. Lower die plate 60 is also referred to herein as a counter plate, a female burst cutting die plate, or a lower burst cutting die plate.

Upper die plate 40 and lower die plate 60 can comprise steel or any other metal material suitable for use in a die cutting press. Either or both die plates can comprise, for example, stainless steel, iron, aluminum, titanium, alloys thereof, and the like. Upper die plate 40 and lower die plate 60 comprise stainless steel in the embodiment shown. Upper die plate 40 and lower die plate 60 can exhibit a level of hardness that is sufficient to keep upper die plate 40 and lower die plate 60 flat during use, and to prevent wearing of the workpiece manipulation features. According to some embodiments, upper die plate 40 and lower die plate 60 can exhibit a Rockwell hardness of at least 40 on the C scale, for example, at least 45, at least 50, or at least 55. According to some embodiments, each of the upper die plate and the lower die plate exhibits a Rockwell hardness of at least 52 on the C scale.

As shown in FIG. 1, upper die plate 40 comprises a mounting surface 42 for mounting against a retaining board and/or die press. Upper die plate 40 comprises a working surface 44 opposite mounting surface 42. Upper die plate, 40 and lower die plate 60 can each comprise a substantially flat mounting surface. Working surface 44 can comprise an area, and a substantially uniform minimum thickness 46 defining a recessed surface 48 across a majority of the area of working surface 44. Substantially uniform minimum thickness 46 can be, for example, from about 0.02 inch to about 0.5 inch, from about 0.05 inch to about 0.4 inch, from about 0.10 inch to about 0.3 inch, or from about 0.12 inch to about 0.2 inch.

Working surface 44 can comprise a plurality of workpiece manipulating features 50 extending from the recessed surface 48 to define areas 52 of working surface 44 having thicknesses 54 that are greater than minimum thickness 46. Thicknesses 54 can be from about 0.04 inch to about 1.0 inch, from about 0.10 inch to about 0.8 inch, from about 0.2 inch to about 0.6 inch, or from about 0.24 inch to about 0.4 inch. The areas of the working surface having thicknesses that are greater than the minimum thickness can together comprise an area that is less than 50% of the total area of the working surface, for example, less than 20%, less than 10%, less than 5%, less than 4%, less than 3%, or less than 2% of the entire area of the working surface. As can be seen in FIG. 2, very little of the area of working surface 44 has a thickness that is greater than the minimum thickness, for example, less than 5% of the total area or less than 3% of the total area. FIG. 2 also shows a retaining board 55 to which upper die plate 40 is fastened.

Lower die plate 60 can have a mounting surface 62 for mounting against a press, and a working surface 64 opposite mounting surface 62. Mounting surface 62 can have an area, and a substantially uniform maximum thickness 66 defining a contact surface 68 across a majority of the area of working surface 64. Substantially uniform maximum thickness 66 can be from about 0.04 inch to about 1.0 inch, from about 0.10 inch to about 0.8 inch, from about 0.2 inch to about 0.6 inch, or from about 0.24 inch to about 0.4 inch.

Working surface 64 can have a plurality of workpiece manipulating features 70 recessed from contact surface 68 to define areas of working surface 64 having thicknesses 72 that are less than maximum thickness 66. Thicknesses 72 can be from about 0.02 inch to about 0.5 inch, from about 0.05 inch to about 0.4 inch, from about 0.10 inch to about 0.3 inch, or from about 0.12 inch to about 0.2 inch. The areas of the working surface having thicknesses that are less than the uniform maximum thickness can together comprise less than 50% of the total area of the working surface, for example, less than 20%, less than 10%, less than 5%, less than 4%, less than 3%, or less than 2% of the entire area of the working surface. As can be seen in FIG. 3, very little of the area of working surface 64 has a thickness that is less than the maximum thickness, for example, less than 5% of the total area or less than 3% of the total area. In operation, workpiece manipulating features 50 of upper die plate 40 can be aligned with workpiece manipulating features 70 of lower die plate 60.

According to one or more embodiments, upper die plate 40 and lower die plate 60 can be an integral part of, or mounted within, a die cutting press. Upper die plate 40 and lower die plate 60 can be mounted within the die cutting press such that workpiece manipulating features 50 of upper die plate 40 are aligned with workpiece manipulating features 70 of lower die plate 60. According to some embodiments, upper die plate 40 and lower die plate 60 can each be adhered or fixed to a retaining board. Each respective retaining board can be mounted to a chase of a die cutting press.

According to some embodiments, after upper die plate 40 and lower die plate 60 are secured to their respective retaining boards, and mounted in respective chases, upper die plate 40 and lower die plate 60 can be aligned with respect to one another, for proper operation in the die press through the use of an alignment skew system. Exemplary alignment systems can comprise, for example, locating pins or dowels in one or both of upper die plate 40 and lower die plate 60, and corresponding locating holes for the pins or dowels, in at least the other of plates 40 and 60. According to some embodiments, four pins extending from four corners of upper die plate 40 can be aligned with corresponding holes defined in corresponding corners of lower die plate 60. According to some embodiments, four pins extending from four corners of lower die plate 60 can be aligned with corresponding holes defined in corresponding corners of upper die plate 40. According to some embodiments, the desired alignment can be achieved using more than four pins or less than four pins. For example, five, three, or two pins can be used to achieve the desired alignment. According to some embodiments, the tolerance between the pins and the holes can 2/1000 inch or greater. For example, the tolerance between the pins and the holes can be 3/1000 inch, 4/1000 inch, 5/1000 inch, or greater.

In various embodiments, other skewing and/or alignment mechanisms and systems can be used, for example, comprising hour-glass-shaped structures, laser detection, and the like.

Upper die plate 40 and lower die plate 60 can be “no knife” dies or burst cutting die plates, which do not employ a knife edge for cutting. As described in more detail below, upper die plate 40 and lower die plate 60 can, for example, produce a desired shape from a workpiece, by burst cutting the workpiece, that is, by exerting sufficient pressure on opposing surfaces of the workpiece to effect a cut of, or punching into, the workpiece.

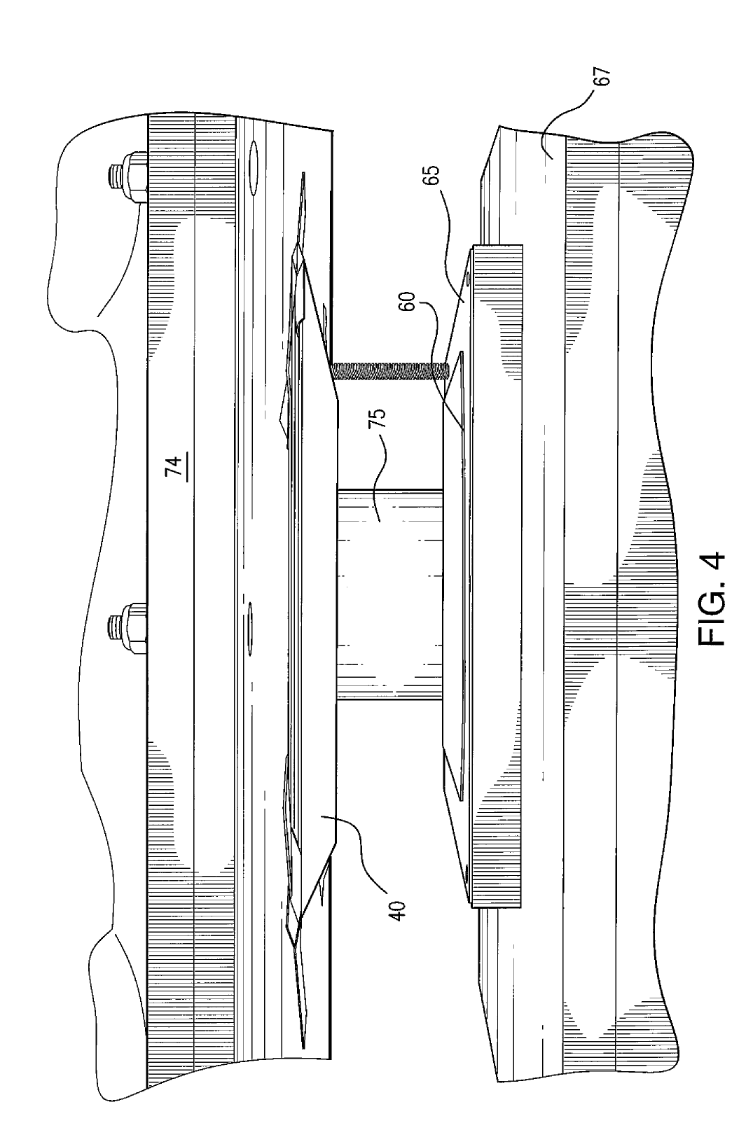

FIG. 4 depicts an exemplary burst cutting die press 74. Burst cutting die press 74 can comprise upper die plate 40 and lower die plate 60. Upper die plate 40 can be mounted to an upper platen of burst cutting die press 74. Lower die plate 60 can be mounted to a lower platen of burst cutting die press 74. In the embodiment shown, lower die plate 60 is mounted to a retaining board 65 held by a chase 67. Lower die plate 60 can be mounted by screws, glue, other adhesive, nails, bolts, rivets, or another fastener or fastening means. In some embodiments, the position of lower die plate 60 can be adjustable by virtue of an adjustable retaining board of chase. Upper die plate 40 can similarly be mounted on a retaining board and/or chase, and can have adjustability in some embodiments. FIG. 4 also shows hydraulic shaft 75 used by the press to bring the upper and lower platens together.

According to various embodiments, a method is provided for burst cutting a workpiece. The method can comprise positioning a workpiece between an upper die plate mounted to an upper platen of a die cutting press, and a lower die plate mounted to a lower platen of the die cutting press. The upper die plate and the lower die plate can be brought together to manipulate the workpiece. According to some embodiments, when the upper die plate and the lower die plate are brought together, the upper die plate and the lower die plate can simultaneously contact opposing surfaces of the workpiece with sufficient pressure to burst cut, punch out, and/or otherwise cut out a desired shape from the workpiece.

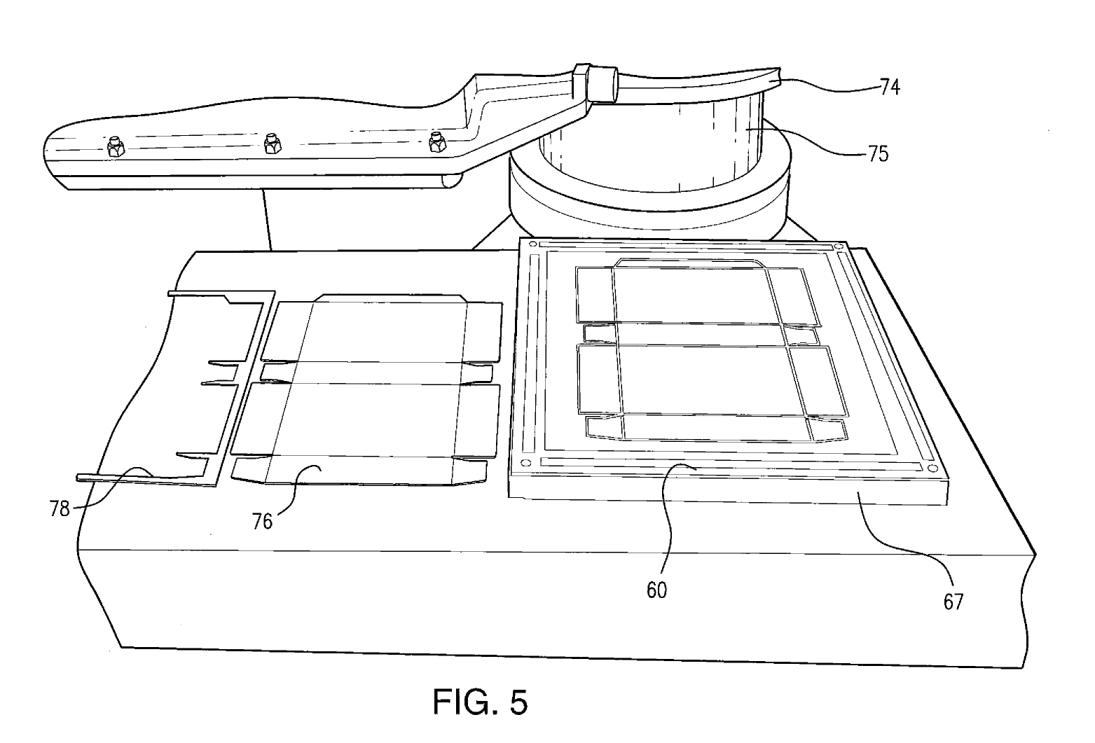

According to various embodiments, die cutting press 74 can burst cut a workpiece such as a paperboard blank, into a desired shape. According to some embodiments, die cutting press 74 can score or crease the paperboard to form appropriate fold lines. FIG. 5 shows the burst cutting die press depicted in FIG. 4, but with the upper die plate 40 removed. Also shown are a paperboard blank 76 that has been burst cut using die press 74, and a paperboard skeleton 72 from which paper board blank 76 has been separated. FIG. 5 also shows hydraulic shaft 75.

Once the desired shape and appropriate fold lines have been achieved, paperboard blank 76 can be assembled into a product, for example, into a paperboard box or a paperboard display.

It is to be understood that the feedstock, blank, or paperboard manipulated by the system can be formed from any sheet material suitable for the desired product. The material can comprise paper, paperboard, cardboard, corrugated cardboard, plastic sheets, plastic films, phenolic layers, corkboard, fiber mat, metal layers, metal foils, web material, combinations thereof, and the like. In some embodiments, the material can be suitable for forming a box or other container. The box can comprise, for example, a paperboard box or corrugated paperboard box used to ship, contain, and/or market consumer products. In some embodiments, the material can be suitable for forming a sign or shaped article such as a flat handprint, a sign to be mounted on a support structure, a foldable article other than a box or container, a display, or the like.

While the present teachings have been described in terms of exemplary embodiments, it is to be understood that changes and modifications can be made without departing from the true scope of the present teachings.

What is claimed is:

1. A set of burst cutting dies comprising an upper die plate and a lower die plate,
the upper die plate comprising a mounting surface for mounting against a press, a working surface opposite the mounting surface and having an area, and a substantially uniform minimum thickness defiling a recessed surface across a majority of the area of the working surface, the working surface comprising a plurality of workpiece manipulating features extending from the recessed surface to define areas of the working surface having thicknesses that are greater than the minimum thickness,
the lower die plate comprising a mounting surface for mounting against a press, a working surface opposite the mounting surface and having an area, and a substantially uniform maximum thickness defining a contact surface across a majority of the area of the working surface, the working surface comprising a plurality of workpiece manipulating features recessed from the contact surface to define areas of the working surface having thicknesses that are less than the maximum thickness,
wherein, in operation, the workpiece manipulating features of the upper die plate are aligned with the workpiece manipulating features of the lower die plate.

2. The set of burst cutting dies of claim 1, wherein each of the upper die plate and the lower die plate comprises stainless steel.

3. The set of burst cutting dies of claim 1, wherein each of the upper die plate and the lower die plate exhibits a Rockwell hardness of at least 40 on the C scale.

4. The set of burst cutting dies of claim 1, wherein each of the upper die plate and the lower die plate comprises a substantially flat respective mounting surface.

5. A die cutting press comprising an upper burst cutting die mounted to an upper platen of the die cutting press, and a lower burst cutting die mounted to a lower platen of the die cutting press,
the upper die plate comprising a mounting surface for mounting against a press, a working surface opposite the mounting surface and having an area, and a substantially uniform minimum thickness defining a recessed surface across a majority of the area of the working surface, the working surface comprising a plurality of workpiece manipulating features extending from the recessed surface to define areas of the working surface having thicknesses that are greater than the minimum thickness,
the lower die plate comprising a mounting surface for mounting against a press, a working surface opposite the mounting surface and having an area, and a substantially uniform maximum thickness defining a contact surface across a majority of the area of the working surface, the working surface comprising a plurality of workpiece manipulating features recessed from the contact surface to define areas of the working surface having thicknesses that are less than the maximum thickness,
wherein the upper and lower die plates are mounted such that the workpiece manipulating features of the upper die plate are aligned with the workpiece manipulating features of the lower die plate.

6. The set of burst cutting dies of claim 5, wherein each of the upper die plate and the lower die plate comprises stainless steel.

7. The set of burst cutting dies of claim 5, wherein each of the upper die plate and the lower die plate exhibits a Rockwell hardness of at least 40 on the C scale.

8. The set of burst cutting dies of claim 5, wherein each of the upper die plate and the lower die plate comprises a substantially flat respective mounting surface.

9. A method of burst cutting a workpiece, comprising:
positioning a workpiece between an upper burst cutting die mounted to an upper platen of a die cutting press, and a lower burst cutting die mounted to a lower platen of the die cutting press; and
bring together the upper burst cutting plate and the lower burst cutting plate to manipulate the workpiece, wherein
the upper die plate comprises a mounting surface for mounting against a press, a working surface opposite the mounting surface and having an area, and a substantially uniform minimum thickness defining a recessed surface across a majority of the area of the working surface, the working surface comprising a plurality of workpiece manipulating features extending from the recessed surface to define areas of the working surface having thicknesses that are greater than the minimum thickness,
the lower die plate comprises a mounting surface for mounting against a press, a working surface opposite the mounting surface and having an area, and a substantially uniform maximum thickness defining a contact surface across a majority of the area of the working surface, the working surface comprising a plurality of workpiece manipulating features recessed from the contact surface to define areas of the working surface having thicknesses that are less than the maximum thickness, and
the upper and lower die plates are mounted such that the workpiece manipulating features of the upper die plate are aligned with the workpiece manipulating features of the lower die plate.

10. The method of claim 9, wherein the manipulating the workpiece comprises burst cutting the workpiece.

11. The method of claim 9, wherein the manipulating the workpiece comprises scoring the workpiece.

12. The method of claim 9, wherein the manipulating the workpiece comprises creasing the workpiece.
